(19) United States
(12) Patent Application Publication
(10) Pub. No.: US 2013/0016426 A1
(43) Pub. Date: Jan. 17, 2013

(54) THREE-DIMENSIONAL GLASSES

(71) Applicant: WEN-LIN CHIANG, Tu-Cheng (TW)

(72) Inventor: WEN-LIN CHIANG, Tu-Cheng (TW)

(73) Assignee: HON HAI PRECISION INDUSTRY CO., LTD., Tu-Cheng (TW)

(21) Appl. No.: 13/417,106

(22) Filed: Mar. 9, 2012

(30) Foreign Application Priority Data
Jul. 11, 2011 (TW) 100124387

(51) Int. Cl. G02B 27/22

(52) U.S. Cl. 359/464

(57) ABSTRACT

A pair of 3D glasses comprises a glasses frame, a pair of nosepieces, a pair of temple arms pivotally mounted on the glasses frame and a power supply. The power supply comprises a battery and a tactile switch located inside one of the pair of nosepieces. The battery supplies power to the glasses when the user wears the glasses and power is turned off when the glasses are not being used by the user.

### TECHNICAL FIELD

The disclosure relates to active type three-dimensional glasses, and more particularly to a pair of three-dimensional glasses with energy conservation.

### DESCRIPTION OF THE RELATED ART

As three-dimensional (3D) videos become popular, 3D glasses for watching these 3D videos are used. 3D glasses may be classified into passive type and active type. The visual 3D effect of the passive type 3D glasses is principally made by visual parallax effect via a pair of optical lenses. Specifically, a pair of passive type 3D glasses may comprise a frame, a pair of lenses such as a blue and a red color filters or a pair of polarized lenses, and a pair of temple arms. No electronics is needed to discern 3D images when using passive type 3D glasses. A pair of active type 3D glasses may contain a pair of 3D display lenses or a pair of 3D liquid crystal glasses to produce the visual parallax effect. However, electronic components in a pair of active type 3D glasses need a power supply to provide power for watching 3D videos. It is difficult to provide power for an extended period due to the restricted size of the battery for the active type 3D glasses. For saving power on the active type 3D glasses, a switch to disconnect the battery from the active electronics, when not in use, may be installed in a pair of active type 3D glasses. However, users may forget to turn off the battery via turning the switch off. Even though the switch can be replaced by an induction type power switch to economize on electrical power, the induction type power switch itself consumes electrical power. Therefore there is room for improvement in the art.

### BRIEF DESCRIPTION OF THE DRAWINGS

FIG. 1 is an exploded diagram of a pair of 3D glasses.

FIG. 2 is an exploded diagram of a power supply of the 3D glasses in accordance with FIG. 1.

FIG. 3 is a cross section of a tactile switch of the 3D glasses in accordance with FIG. 2.

FIG. 4 is a cross section showing an off-state of the tactile switch of the 3D glasses in accordance with FIG. 3.

FIG. 5 is a cross section showing an on-state of the tactile switch of the 3D glasses in accordance with FIG. 3.

### DETAILED DESCRIPTION

Exemplary embodiments of the disclosure will be described with reference to the accompanying drawings.

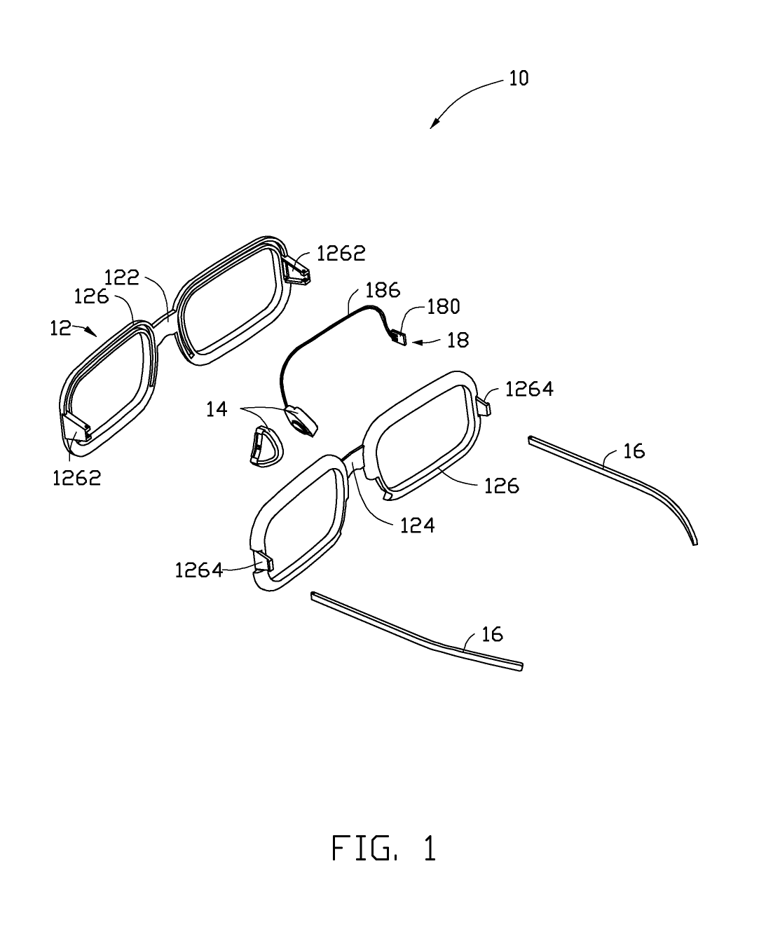

Referring to FIG. 1, the disclosure provides a pair of 3D glasses 10 comprising a glass frame 12, a pair of nosepieces 14, a pair of temple arms 16 and a power supply 18.

The glass frame 12 comprises a front frame 122, a rear frame 124 and a pair of lens-frames 126 for inserting a pair of 3D displays lenses (not shown), wherein the front frame 122 is symmetrical to the rear frame 124 and the lens-frames 126 are bilateral-symmetrical to each other. A U-shaped articulate portion 1262 extends from two opposite ends of the front frame 122. A joint extreme 1264 extends from two opposite ends of the rear frame 124 that also forms as a U-shaped structure. While the front frame 122 engages with the rear frame 124, the two articulate portions 1262 respectively engage with the two joint extremes 1264. The pair of temple arms 16 is pivotally mounted on the two articulate portions 1262 so as to be foldable inwards or unfoldable outwards. Moreover, the power supply 18 is located between the front frame 122 and the rear frame 124, and extends from one of the two articulate portions 1262 to one of the pair of nosepieces 14. The pair of nosepieces 14 is adjacent to the glass frame 12 between the pair of lens-frames 126.

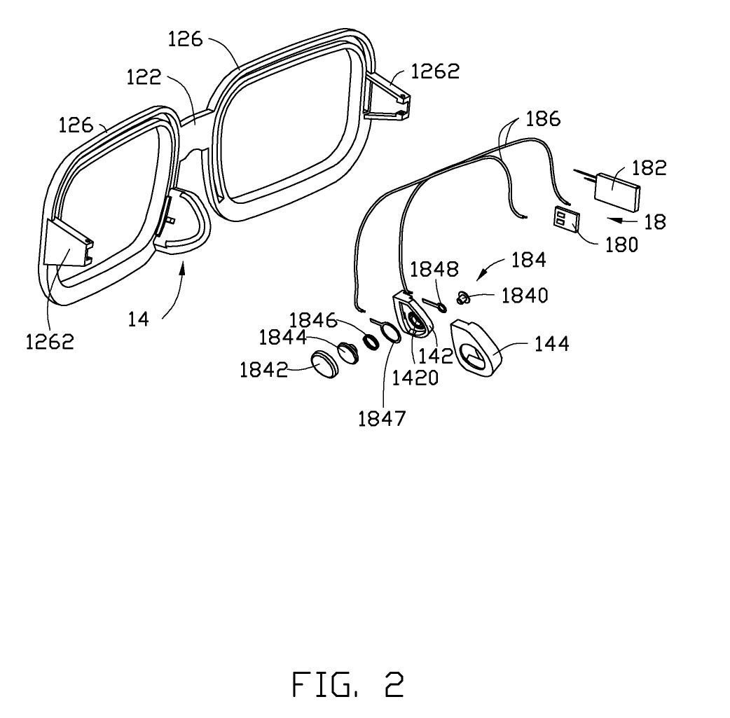

Referring to FIG. 2, the power supply 18 comprises a battery 182 and a tactile switch 184, wherein the battery 182 is used to provide power. The battery 182 is located on a circuit board 180 inside the articulate portion 1262. In the embodiment, the tactile switch 184 is located inside one of the pair of nosepieces 14; alternatively, there also can be a tactile switch 184 located inside both nosepieces 14 (not shown). The nosepiece 14 comprises a nosepiece seat 142 and a nosepiece bag 144, wherein the nosepiece bag 144 covers the nosepiece seat 142. Further, the nosepiece seat 142 comprises an aperture 1420 through the nosepiece seat 142, wherein the aperture 1420 is configured for receiving the tactile switch 184. The battery 182 outputs current via conductive wires 186 through the tactile switch 184. The battery 182, the tactile switch 184 and conductive wires 186 are configured as a closed-circuit.

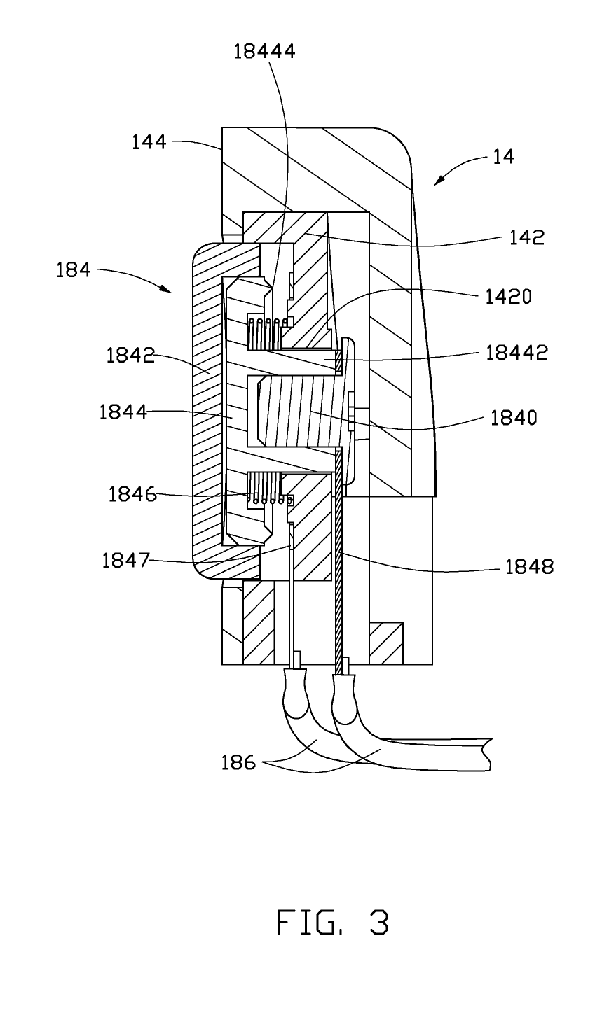

Referring to FIG. 2 and FIG. 3, the tactile switch 184 comprises a plastic tape 1842, a button 1844, a spring 1846, two conductive coils 1847 and 1848, and a screw 1840. The plastic tape 1842 covers a top face of the button 1844 to prevent corrosion on a surface of the button 1844 and electrical leakage (see following description). A pillar 18442 extends from a rear face of the button 1844, and is inserted into the aperture 1420 (as shown in FIG. 3), whereby the button 1844 is engaged with the nosepiece seat 142. The spring 1846 has a very low pressure rating and is located between the button 1844 and the nosepiece seat 142, by which the button 1844 is held away from nosepiece seat 142 and out of electrical contact from the conductive coil 1847, but can be manually pressed downward against spring pressure from the force of the spring 1846 to make electrical contact with the conductive coil 1847. The pillar 18442 of the button 1844 is fixed into the aperture 1420 by the screw 1840 such that the button 1844 is held captive in the nosepiece seat 142. The two conductive coils 1847 and 1848 have different electric properties and, respectively, electrically connect to the two conductive wires 186. In the embodiment, the conductive coil 1847 is an anode and the conductive coil 1848 is a cathode. The conductive coil 1847 is located on a top surface of the nosepiece seat 142, and surrounds the aperture 1420 of the nosepiece seat 142. The conductive coil 1847 corresponds to the rear face of the button 1844, more specifically, to a projection 18444 from the button 1844. The conductive coil 1848 is located on a rear face of the nosepiece seat 142 which is opposite to the conductive coil 1847. Moreover, the screw 1840 is latched on the nosepiece seat 142 and located on the pillar 18442 of the button 1844. In the embodiment, the button 1844 and the screw 1840 are electrically-conductive and contacts each other, wherein the button 1844 and the screw 1840 can be metallic or metallic means. Therefore, the button 1844 and the screw 1840 have an electric property which is equal to that of the conductive coil 1848.

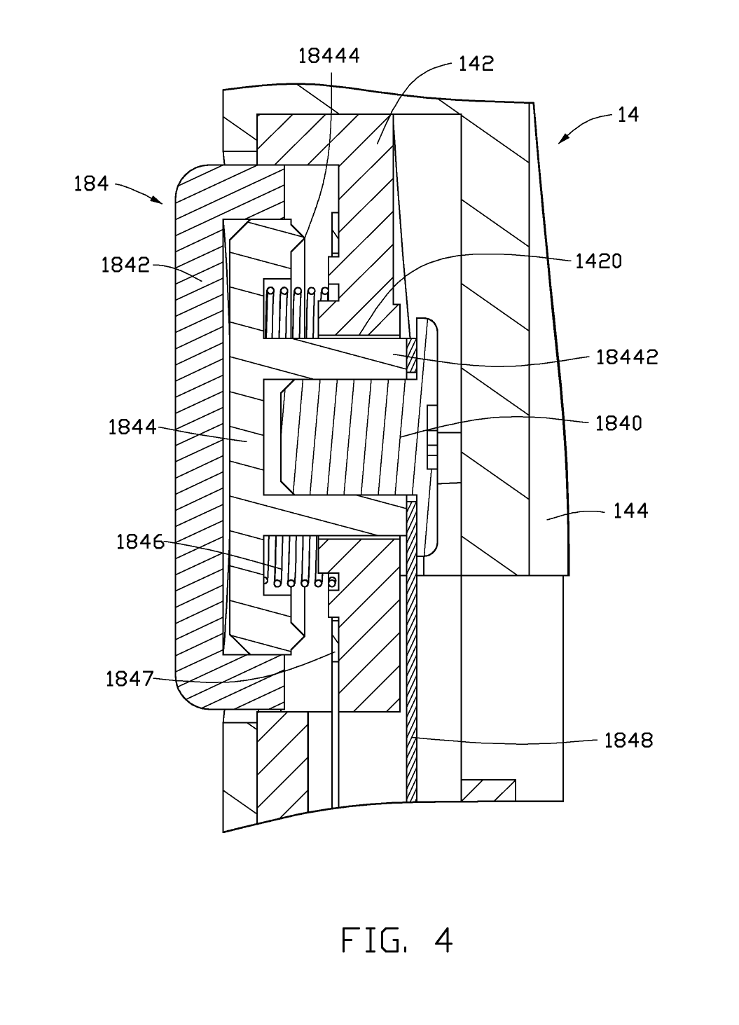

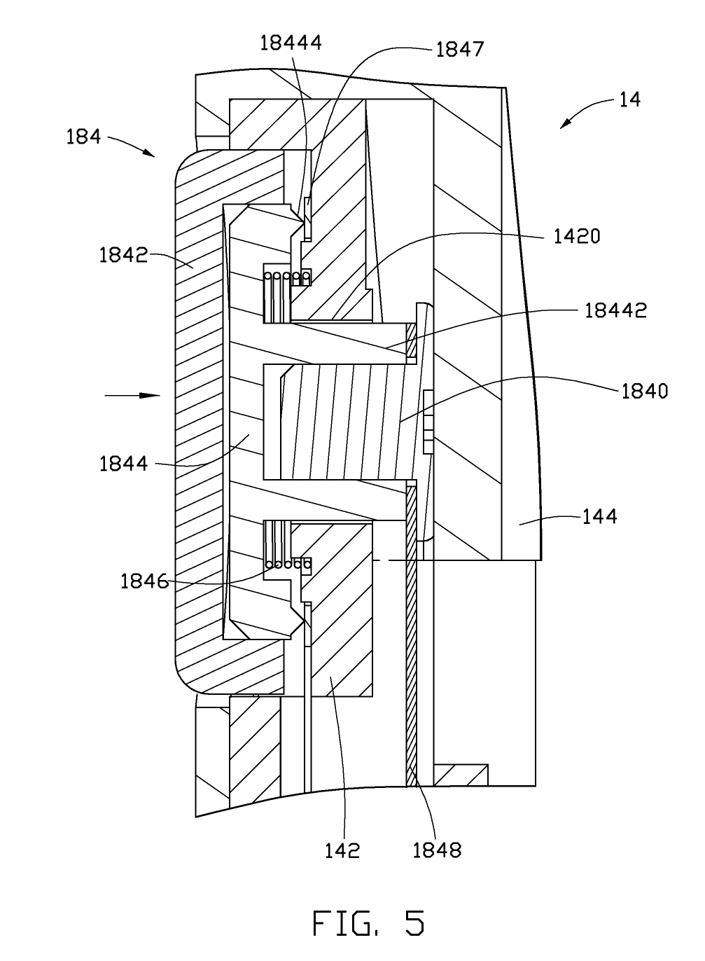

In the embodiment, the negative-terminal conductive coil 1848 electrically connects to the button 1844 that makes the button 1844 as a negative terminal. Referring to FIG. 4, when the 3D glasses 10 is not being used, the tactile switch 184 bulges from the nosepiece 14 by pressure from the spring 1846 and the projection 18444 of the button 1844 is separated from the conductive coil 1847. In this situation, the two conductive coils 1847 and 1848 are open-circuit, and the power of the battery 182 is not consumed. As shown in FIG. 5, when the 3D glasses 10 are in place on the face of a user, the weight of the glasses 10 bears down on the button 1844 of the tactile switch 184 such that electrical contact is made with the conductive coil 1847, the positive pole, via the projection 18444. The two conductive coils 1847 and 1848 then become closed-circuit, and electrical power can reach the 3D glasses 10. Furthermore, when the 3D glasses 10 are removed by the wearer, the spring 1846 forces the tactile switch 184 to again bulge out of the nosepiece 14, and the two conductive coil 1847 and 1848 become open-circuit again.

Accordingly, the battery 182 can work only when the user wear the glasses, achieving significant energy savings. Moreover, the 3D glasses 10 of the present disclosure have simple structure and are convenient to use.

It is to be understood, however, that even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A three-dimension glasses, comprising:
a glasses frame, containing a pair of lens-frames which are bilateral-symmetrical to each other;
a pair of nosepieces, adjacent to the glasses frame between the pair of lens-frames;
a pair of temples arms, pivotally mounted on two ends of the glasses frame; and
a power supply, located inside the glasses frame and extending to one of the pair of nosepieces, comprising a battery and a tactile switch, wherein the tactile switch is located inside one of the pair of nosepieces and electrically connects to the battery via conductive wires.

2. The three-dimension glasses as claimed in claim 1, wherein the glasses frame comprises a front frame and a rear frame symmetrical to each other.

3. The three-dimension glasses as claimed in claim 2, wherein a U-shaped articulate portion extends from two opposite ends of the front frame, and a U-shaped joint extreme respectively extends from two opposite ends of the rear frame.

4. The three-dimension glasses as claimed in claim 2, wherein the battery is located on a circuit board inside one of the articulate portions.

5. The three-dimension glasses as claimed in claim 1, wherein there is one tactile switch located inside each one of the pair of nosepieces.

6. The three-dimension glasses as claimed in claim 1, wherein the nosepiece comprises a nosepiece seat and a nosepiece bag covering the nosepiece seat, and the nosepiece bag comprises an aperture through the nosepiece seat.

7. The three-dimension glasses as claimed in claim 6, wherein the tactile switch comprises a plastic tape, a button, a spring, two conductive coils and a screw, and the spring is located between the button and the nosepiece seat.

8. The three-dimension glasses as claimed in claim 7, wherein a pillar extends from a rear face of the button and inserts into the aperture, whereby the button is engaged with the nosepiece seat.

9. The three-dimension glasses as claimed in claim 8, wherein the screw is latched on the nosepiece seat and located on the pillar of the button, and electrically connects to the button.

10. The three-dimension glasses as claimed in claim 7, wherein there are two conductive coils with different electric properties and, respectively, electrically connect to the conductive wires.

11. The three-dimension glasses as claimed in claim 10, wherein one of the conductive coils is located on a top surface of the nosepiece seat corresponding to the rear face of the button, and the other conductive coil is located on a rear face of the nosepiece seat.

12. A three-dimension glasses, comprising:
a glasses frame, containing a pair of lens-frames which are bilateral-symmetrical to each other;
a pair of nosepieces, adjacent to the glasses frame between the pair of lens-frames;
a pair of temples arms, pivotally mounted on two ends of the glasses frame; and
a power supply, located inside the glasses frame and extending to one of the pair of nosepieces, comprising a battery and two tactile switches, wherein the two tactile switches are located inside each one of the pair of nosepieces and electrically connects to the battery via conductive wires.

13. The three-dimension glasses as claimed in claim 12, wherein the glasses frame comprises a front frame and a rear frame symmetrical to each other.

14. The three-dimension glasses as claimed in claim 13, wherein a U-shaped articulate portions extend from two opposite ends of the front frame, and a U-shaped joint extreme extends from two opposite ends of the rear frame.

15. The three-dimension glasses as claimed in claim 12, wherein the nosepiece comprises a nosepiece seat and a nosepiece bag covering the nosepiece seat, and the nosepiece bag comprises an aperture through the nosepiece seat.

16. The three-dimension glasses as claimed in claim 15, wherein the tactile switch comprises a plastic tape, a button, a spring, two conductive coils and a screw, and the spring is located between the button and the nosepiece seat.

17. The three-dimension glasses as claimed in claim 16, wherein a pillar extends from a rear face of the button and inserts into the aperture, whereby the button is engaged with the nosepiece seat.

18. The three-dimension glasses as claimed in claim 17, wherein the screw is latched on the nosepiece seat and located on the pillar of the button, electrically connects to the button.

19. The three-dimension glasses as claimed in claim 16, wherein there are two conductive coils with different electric properties and, respectively, electrically connect to the conductive wires.

20. The three-dimension glasses as claimed in claim 19, wherein one of the conductive coils is located on a top surface of the nosepiece seat corresponding to the rear face of the button, and the other conductive coil is located on a rear face of the nosepiece seat.
